(19) United States
(12) Patent Application Publication
(10) Pub. No.: US 2013/0093120 A1
(43) Pub. Date: Apr. 18, 2013

(54) MOLDING SURFACE-HEATING APPARATUS AND MOLDING METHOD

(71) Applicants: Haruka Ito, Tochigi (JP); Susumu Horinaka, Tochigi (JP); Ayato Ueha, Tochigi (JP)

(72) Inventors: Haruka Ito, Tochigi (JP); Susumu Horinaka, Tochigi (JP); Ayato Ueha, Tochigi (JP)

(73) Assignee: HONDA MOTOR CO., LTD., Tokyo (JP)

(21) Appl. No.: 13/595,199

(22) Filed: Aug. 27, 2012

(30) Foreign Application Priority Data
Oct. 17, 2011 (JP) 2011-228044

(51) Int. Cl. B29C 35/08

(52) U.S. Cl. 264/403; 425/3

(57) ABSTRACT

In a molding surface-heating apparatus, eddy current is generated in a mold by an electromagnetic induction, and a molding surface of the mold is heated by the eddy current. The molding surface-heating apparatus is provided with a conductive member and a coil. The conductive member is electrically connected to and disconnected from a surface of the mold. The coil supplies a magnetic flux to the conductive member and the mold such that the magnetic flux generates the eddy current that crosses the conductive member and the mold and the eddy current passes through the molding surface.

### BACKGROUND OF THE INVENTION

1. Field of the Invention

The present invention relates to a molding surface-heating apparatus and a molding method, in which a molding surface of a mold is heated by an induction heating.

2. Related Art

In a molding of a resin product, there may be a case that, after molding the product in a heated mold, the molded product is cooled inside the mold to a temperature at which the molded product can be taken from the mold without being deformed. In this case, since heating and cooling of the mold are repeated in each molding cycle, it is necessary to rapidly perform the heating and cooling of the mold in each molding cycle in order to reduce a cycle time.

In order to rapidly perform the heating and cooling of the mold, it is preferable that only a surface including a molding surface of the mold is locally heated. As a method for locally heating the surface of the mold, a heating of the mold by an induction heating is known.

For example, Patent Document 1 (JP-A-2007-535786) discloses a technology of heating an intermediate element such as a mold, which is disposed between an inductor and a molding material, by applying an electric field generated by the inductor to the intermediate element. According to this technology, a gap or an insulator is disposed inside the intermediate element such that current induced in the intermediate element by the electric field circulates along the surface of the outer surface of the outer surface of the intermediate element.

In order to rapidly heat the molding surface of the mold by the induction heating, it is necessary to generate greater induced electromotive force. The induced electromotive force is represented by ε=−NS(dB/dt) according to Faraday's Law. Here, N is the number of turns of a coil, S is the area through which magnetic flux passes, and dB/dt is the variation of magnetic flux density depending on time.

Therefore, when a magnetic flux generated by a coil is applied to the mold, the induced electromotive force can be increased by changing the number of turns of the coil. However, this has a limitation. In addition, as in Patent Document 1 as described above, the induced electromotive force of eddy current that passes through the molding surface may be increased by properly designing the shape of the mold or the like. However, this also has a limitation.

Therefore, if there is another method of effectively increasing the electromotive force that is induced to the mold, it is preferable since the molding surface of the mold can be more rapidly heated via induction heating.

### SUMMARY OF THE INVENTION

Embodiments of the invention relate to a molding surface-heating apparatus and a molding method, in which a molding surface of a mold can be more rapidly heated via induction heating.

### BRIEF DESCRIPTION OF THE DRAWINGS

FIG. 1(a) is schematic front elevation view of a molding apparatus to which a molding surface-heating apparatus according to an embodiment is applied.

FIG. 1(b) is a sectional view taken along A-A line of FIG. 1(a).

FIG. 2 is a perspective view schematically depicting a state in which eddy current flows in the molding apparatus shown in FIG. 1(a).

FIG. 3 is a graph showing a variation of a temperature of a molding surface depending on time when a pair of molds of the molding apparatus shown in FIG. 1(a) is heated and cooled, together with variations of comparative examples.

FIG. 4 is a view showing a state in which a pair of molds is heated without using the conductive member.

FIG. 5 is a view showing a state in which a pair of molds is heated using two conductive members, which are connected to both ends of the respective molds.

### DETAILED DESCRIPTION OF THE EMBODIMENTS

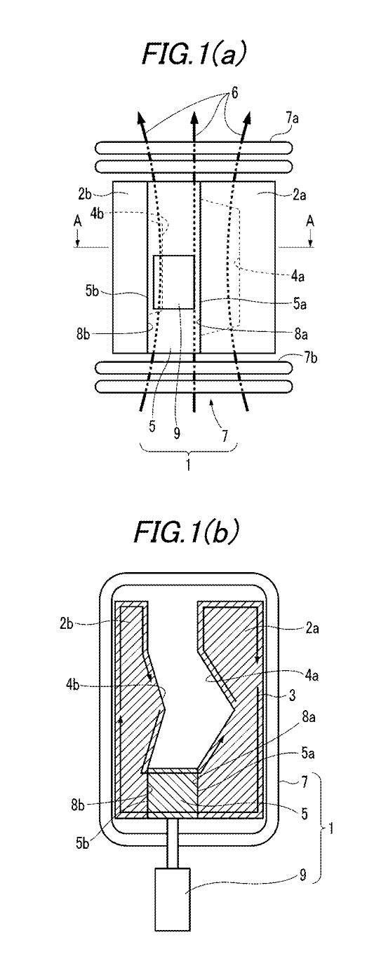

An exemplary embodiment of the invention will be described hereinafter with reference to the accompanying drawings. FIG. 1 (a) is a schematic front elevation view of a molding apparatus to which a molding surface-heating apparatus according to the exemplary embodiment is applied. FIG. 1 (b) is a cross-sectional view taken along A-A in FIG. 1 (a). As shown in FIGS. 1(a) and 1(b), the molding surface-heating apparatus 1 heats molding surfaces 4a and 4b of a pair of molds 2a and 2b by generating eddy current 3 in the pair of molds 2a and 2b via electromagnetic induction.

In order to heat the molding surfaces 4a and 4b via induction heating, the molding surface-heating apparatus 1 includes a conductive member 5, which is electrically connected to and disconnected from surfaces of the molds 2a and 2b other than the molding surfaces 4a and 4b, and a coil 7, which supplies a magnetic flux 6 to the conductive member 5 and the molds 2a and 2b when the conductive member 5 is electrically connected to the molds 2a and 2b. The supply of the magnetic flux 6 is performed so as to generate the eddy current 3 that crosses the conductive member 5 and the molds 2a and 2b and passes through the molding surfaces 4a and 4b.

FIG. 1(b) shows a state in which the conductive member 5 is electrically connected to the molds 2a and 2b. Each of the molds 2a and 2b has a box-like outer shape in the closed state, and is disposed such that the upper and lower surfaces are perpendicular to the central axis of the coil 7. Therefore, a joining surface (parting surface) of the molds 2a and 2b is parallel to the central axis of the coil 7.

The conductive member 5 has the shape of a prism the length of which is the same as the height of the molds 2a and 2b, and is connected to the molds 2a and 2b in the state in which the central axis thereof is parallel to the central axis of the coil 7. Among side surfaces of the conductive member 5, the two opposing side surfaces for connection surfaces 5a and 5b to which the respective molds 2a and 2b are to be electrically connected. Parts of the joining surfaces of the molds 2a and 2b form connection surfaces 8a and 8b that have the same area and shape as the connection surfaces 5a and 5b.

The connection of the conductive member 5 to the molds 2a and 2b is performed by disposing the conductive member 5 between the molds 2a and 2b such that the respective connection surfaces 5a and 5b oppose the connection surfaces 8a and 8b and by bringing the connection surfaces 5a and 5b into close contact with the connection surfaces 8a and 8b. The operation of the conductive member 5 when connecting and disconnecting the conductive member 5 to and from the molds 2a and 2b is enabled by a drive means 9.

For a material of the conductive member 5, a material that has as low electrical resistance as possible is preferable. For example, a steel material or an aluminum material corresponds to such a material.

In the state in which the conductive member 5 is connected to the molds 2a and 2b, the overall outer shape of the molds 2a and 2b and the conductive member 5 has a substantially box-like shape. The coil 7 has a size that can surround the box-like shape, as shown in FIG. 1 (b), when seen in the axial direction thereof, and is disposed such as to surround the box-like shape.

However, as shown in FIG. 1 (a), the coil 7 is composed of a coil portion 7a, which is disposed above and adjacent to the upper end of the molds 2a and 2b to which the conductive member 5 is connected, and a coil portion 7b, which is disposed under and adjacent to the lower end of the molds 2a and 2b.

The coil 7 is divided into the coil portion 7a and the coil portion 7b in this way in order to prevent the coil 7 from interfering with the molds 2a and 2b or the conductive member 5 when the conductive member 5 operates. Therefore, when measures are made such that the opening/closing of the molds 2a and 2b or the operation of the conductive member 5 is not troubled even though the coil 7 is not divided, it is not necessary to divide the coil 7.

In the above-described configuration, when a workpiece is molded using a molding material such as resin, a connection process of electrically connecting the conductive member 5 to the molds 2a and 2b is performed first.

That is, the conductive member 5 is disposed between the molds 2a and 2b which are in an open condition by the drive means 9. This disposition is performed such that the respective connection surfaces 8a and 8b of the molds 2a and 2b oppose the connection surfaces 5a and 5b of the conductive member 5. In addition, moving the molds 2a and 2b in the direction in which the molds 2a and 2b are closed causes the respective connection surfaces 5a and 5b to come into close contact with the contact surfaces 8a and 8b.

This electrically connects the conductive member 5 to the molds 2a and 2b. This also electrically connects the molds 2a and 2b to each other via the conductive member 5, which is interposed therebetween.

In sequence, a heating process of heating the molding surfaces 4a and 4b of the molds 2a and 2b is performed. The heating of the molding surfaces 4a and 4b is performed by supplying high-frequency current to the coil 7. When the high-frequency current is supplied to the coil 7, a high-frequency magnetic flux 6 passes along a path that is substantially perpendicular to the respective cross-sections of the conductive member 5 and the molds 2a and 2b (cross-sections parallel to the cross section of FIG. 1 (b)), thereby generating eddy current 3 along the respective cross-sections.

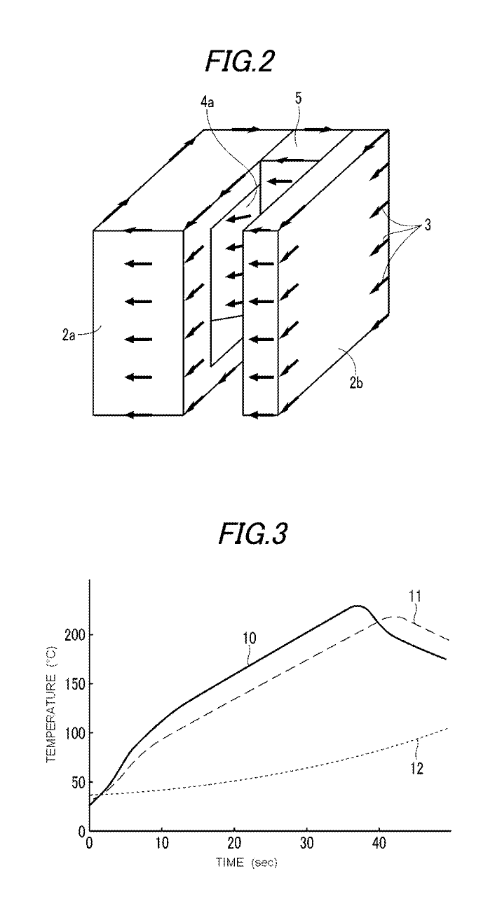

FIG. 2 is a perspective view schematically depicting the state in which the eddy current 3 flows. Since the conductive member 5 and the molds 2a and 2b are electrically integrated together, the eddy current 3 flows along a loop-shaped path that extends along the conductive member 5 and the molds 2a and 2b, as shown in FIG. 2. This path is formed parallel to the respective cross-sections of the conductive member 5 and the molds 2a and 2. In addition, since the eddy current 3 is of a high frequency, a skin effect occurs. That is, when the eddy current 3 is closer to the surface of a conductor in which the conductive member 5 and the molds 2a and 2b are integrated together, the current density of the eddy current 3 is higher.

Therefore, in the cross-sections in which the molding surfaces 4a and 4b of the molds 2a and 2b are present, the eddy current 3 flows substantially along the molding surfaces 4a and 4b. This causes the molding surfaces 4a and 4b to be efficiently and rapidly heated due to Joule heat caused by the eddy current 3. In the meantime, there occurs no eddy current that circulates through only the inside of the mold 2a or 2b or the conductive member 5.

After the heating process, the molds 2a and 2b are moved in the direction in which the molds 2a and 2b are opened, and thus the conductive member 5 is disconnected from the molds 2a and 2b. In addition, the drive means 9 causes the conductive member 5 to retract from between the molds 2a and 2b.

In sequence, a molding process of heating the workpiece using the molds 2a and 2b in which the heated molding surfaces 4a and 4b thereof were heated in the heating process is performed. That is, the molds 2a and 2b are moved in the direction in which they are closed so as to be closed, thereby forming a cavity between the molding surfaces 4a and 4b. A molten molding material is injected into the cavity, thereby filling up the cavity. While the filling is being performed, the molding material is being properly kept warm by the heating surfaces 4a and 4b. Thus, the filling is performed without a problem, and the workpiece is molded.

In sequence, a cooling process of cooling the molds 2a and 2b is performed. That is, the molds 2a and 2b are cooled down to a temperature at which the molded workpiece can be removed from the molds with no difficulties. Here, in the above-described heating process, due to the skin effect, the surfaces of the molds 2a and 2b are mainly heated but the molds 2a and 2b are not heated to the deep portions thereof. Therefore, the molds 2a and 2b are rapidly cooled.

After the cooling process, the molds 2a and 2b are opened and a molded product is taken out. Thereby, the molding of one cycle is completed.

FIG. 3 is a graph showing variation in the temperature of the molding surfaces 4a and 4b depending on the time when the molds 2a and 2b were heated and cooled using the conductive member 5 as in the exemplary embodiment. FIG. 3 shows, together with a graph curve 10 that shows this variation depending on the time for the exemplary embodiment, same types of graph curves for comparison, including a graph curve 11 and a graph curve 12 in which heating were performed under different conditions.

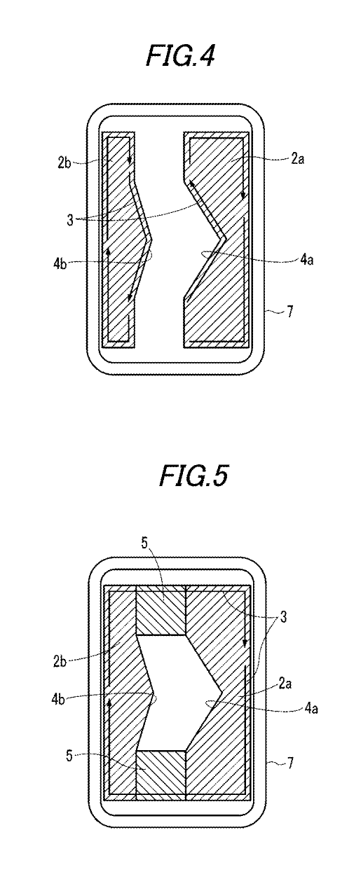

The graph curve 11 shows the time variation in the temperature of the molding surfaces 4a and 4b when the molds 2a and 2b were heated without using the conductive member 5, as shown in FIG. 4. The graph curve 12 shows the time variation in the temperature of the molding surfaces 4a and 4b when the molds 2a and 2b were heated by connecting two conductive members 5 to both the molds 2a and 2b, as shown in FIG. 5. As for the other conditions rather than those of the conductive member 5, the conditions in which the graph curves 11 and 12 were obtained are the same as the conditions in which the graph curve 10 was obtained.

Referring to FIG. 3, in the case of the exemplary embodiment, as indicated by the graph curve 10, the temperature of the molding surfaces 4a and 4b started to rise just after the heating was started and that were rapidly cooled down when the cooling was performed after the heating was stopped. That is, the molding surfaces 4a and 4b were more rapidly heated and cooled than in the case indicated by the graph curve 11 in which the conductive member 5 was not used.

It is considered that this difference is caused by the difference between the paths of the eddy current 3. That is, in this embodiment, as shown in FIG. 1 (b), the eddy current 3 flows along the path that surrounds a relatively large area, which extends through the conductive member 5 to the molds 2a and 2b. At that time, the eddy current 3 is relatively large current because relatively large induced electromotive force is generated by the magnetic flux 6 from the coil 7 that passes through that path.

In contrast, when the conductive member 5 is not used, as shown in FIG. 4, the eddy current 3 flows along respective closed paths inside the molds 2a and 2b. This causes a small amount of variation in the magnetic flux 6 that passes through the eddy current 3, so that the magnetic flux 6 induces a small amount of electromotive force. Therefore, it is considered that the eddy current 3 is smaller than that of this embodiment.

In addition, as shown in FIG. 5, when the two conductive members 5 are connected to both the molds 2a and 2b, it can be appreciated that there was substantially no rise in the temperature right after the heating was started but the temperature started to rise after that, as indicated by the graph curve 12.

This is considered because, in the case of FIG. 5, the eddy current 3 mainly flows along the outer surface of the conductor, owing to an annular conductor being formed by the molds 2a and 2b and the two conductive members 5. In this case, the molding surfaces 4a and the 4b, which are present in the inner surface of the annular conductor, are not heated when the heating is started, but heat from the outer surface is transferred to the molding surfaces 4a and 4b later. Therefore, the rise in the temperature of the molding surfaces 4a and 4b is delayed.

As described above, according to the exemplary embodiment, the conductive member 5 is provided so as to be electrically connected to and disconnected from the other surfaces of the pair of molds 2a and 2b than the molding surfaces 4a and 4b of the molds 2a and 2b, and the eddy current 3 is formed so as to cross the conductive member 5 and the molds 2a and 2b and to flow through the molding surfaces 4a and 4b when the molds 2a and 2b are heated. Therefore, it is possible to more rapidly heat the molding surfaces 4a and 4b of the molds 2a and 2b via induction heating than the related art.

In the meantime, the present invention is not limited to the above-described embodiments. For example, although the foregoing embodiments have been described with respect to the case in which the molding is performed by filling the cavity with the molding material, this is not intended to be limiting. Rather, the invention can be applied to the case in which the molding surfaces of the molds are heated and the molding is performed using the molding surfaces without forming the cavity.

For example, the invention can be applied to the case in which the molding is performed by pressing an object to be molded between the molding surfaces of two molds, or the molding is performed by placing a molding material on the molding surface of one mold.

In accordance with the embodiments and examples, a molding surface-heating apparatus for heating a molding surface of a mold by generating eddy current in the mold by an electromagnetic induction may include: a conductive member electrically connected to and disconnected from a surface of the mold other than the molding surface of the mold; and a coil that supplies a magnetic flux to the conductive member and the mold, wherein the magnetic flux generates the eddy current that crosses the conductive member and the mold and passes through the molding surface, when the conductive member is electrically connected to the mold.

According to this structure, the magnetic flux generated by the coil is supplied to the conductive member and the mold. Thereby, the eddy current that crosses the conductive member and the mold and passes through the molding surface is generated. Accordingly, in the present invention, the eddy current circulates along the path that surrounds a greater area than that of the related art in which the eddy current is formed only inside the mold by the magnetic flux that is supplied only to the mold. The magnitude of the induced electromotive force that generates the eddy current is proportional to the time variation in the magnetic flux in the path along which the eddy current flows.

According to this structure, it is possible to increase the induced electromotive force that generates the eddy current by increasing the magnetic flux that passes through the path of the eddy current. Therefore, the molding surface of the mold can be rapidly induction-heated using a great amount of eddy current.

In accordance with the embodiments and examples, a molding surface-heating apparatus for heating molding surfaces of a pair of molds by generating eddy current in the molds by an electromagnetic induction may include: a conductive member electrically connected to and disconnected from surfaces of the molds other than the molding surfaces, wherein the pair of molds are electrically connected to each other through the conductive member when the conductive member is electrically connected to the molds; and a coil that supplies a magnetic flux to the conductive member and the molds, wherein the magnetic flux generates the eddy current that crosses the conductive member and the molds and passes through the molding surfaces of both of the molds, when the conductive member is electrically connected to the molds.

According to this structure, since the eddy current that influences the conductive member and both parts of the pair of molds is formed, the size of the eddy current is more effectively increased. Therefore, it is possible to more rapidly heat the molding surface of the molds via induction heating.

Moreover, in accordance with the embodiments and examples, a molding method may include: a step of electrically connecting a conductive member to a portion of a mold other than a molding surface of the mold; a step of heating the molding surface by supplying a magnetic flux, which generates eddy current that crosses the conductive member and the mold and passes through the molding surface, after the step of electrically connecting of the conductive member and the mold; a step of molding a workpiece using the mold with the molding surface thereof being heated; and a step of cooling the mold in a state in which the conductive member is disconnected from the mold, after the step of molding.

According to this method, in the step of heating, since the eddy current that crosses the conductive member and the mold and passes through the molding surface is generated, the eddy current circulates along the path that surrounds a greater area than that of the related art in which the eddy current is formed only inside the mold by the magnetic flux that is supplied only to the mold. This causes the heating to be performed using a greater amount of eddy current by increasing the induced electromotive force by increasing the magnetic flux that passes through the path of the eddy current. Therefore, the molding surface of the mold can be rapidly induction-heated using a great amount of eddy current.

What is claimed is:

1. A molding surface-heating apparatus, in which eddy current is generated in a mold by an electromagnetic induction and a molding surface of the mold is heated by the eddy current, the apparatus comprising:
a conductive member electrically connected to and disconnected from a surface of the mold other than the molding surface of the mold; and
a coil that supplies a magnetic flux to the conductive member and the mold, wherein the magnetic flux generates the eddy current that crosses the conductive member and the mold and passes through the molding surface, when the conductive member is electrically connected to the mold.

2. A molding surface-heating apparatus, in which eddy current is generated in a pair of molds by an electromagnetic induction and molding surfaces of the molds are heated by the eddy current, the apparatus comprising:
a conductive member electrically connected to and disconnected from surfaces of the molds other than the molding surfaces, wherein the pair of molds are electrically connected to each other through the conductive member when the conductive member is electrically connected to the molds; and
a coil that supplies a magnetic flux to the conductive member and the molds, wherein the magnetic flux generates the eddy current that crosses the conductive member and the molds and passes through the molding surfaces of both of the molds, when the conductive member is electrically connected to the molds.

3. A molding method comprising:
electrically connecting a conductive member to a portion of a mold other than a molding surface of the mold;
heating the molding surface by supplying a magnetic flux, which generates eddy current that crosses the conductive member and the mold and passes through the molding surface, after the electrically connecting of the conductive member and the mold;
molding a workpiece using the mold with the molding surface thereof being heated; and
cooling the mold in a state in which the conductive member is disconnected from the mold, after the molding.
